(19) United States
(12) Patent Application Publication
(10) Pub. No.: US 2022/0042523 A1
(43) Pub. Date: Feb. 10, 2022

(54) FUEL SUPPLY APPARATUS

(71) Applicants: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(72) Inventors: Nobutaka TESHIMA, Toyota-shi (JP); Masaaki MATSUSUE, Mishima-shi (JP)

(73) Assignees: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(21) Appl. No.: 17/276,002

(22) PCT Filed: Oct. 9, 2019
(86) PCT No.: PCT/JP2019/039814

§ 371 Date: Mar. 12, 2021

(30) Foreign Application Priority Data
Nov. 15, 2018 (JP) 2018-214909

(51) Int. Cl. F04F 5/16; F04F 5/54; H01M 8/04746

(52) U.S. Cl. CPC F04F 5/16; H01M 2250/20; H01M 8/04753; F04F 5/54

(57) ABSTRACT

This fuel supply apparatus includes a fuel injection unit for injecting a gaseous fuel to be supplied to a fuel cell, and an injection control unit for controlling the fuel injection unit, wherein the fuel injection unit is provided with a first fuel injection valve capable of injecting the gaseous fuel by maintaining an opening degree of an injection port for the gaseous fuel at a prescribed opening degree between a fully closed opening degree and fully open opening degree, and a second fuel injection valve for intermittently injecting the gaseous fuel, and wherein the injection control unit controls actuation of the first fuel injection valve and actuation of the second fuel injection valve in coordination.

### TECHNICAL FIELD

The present disclosure relates to a fuel supply apparatus for supplying gas fuel to a fuel cell.

### BACKGROUND ART

Patent Document 1 discloses a fuel circulation apparatus provided one or more first injectors and one or more second injectors, each configured to inject gas fuel to be supplied to a fuel cell.

### RELATED ART DOCUMENTS

### Patent Documents

Patent Document 1: Japanese unexamined patent application publication No. 2011-179333

### SUMMARY OF INVENTION

### Problems to be Solved by the Invention

In an injector, a valve (a valve element) will strike a seat part (a valve seat) every time injection is performed. Accordingly, as the number of injections of the injector increases and thus the number of times the valve strikes the seat part increases, the valve and the seat part may be damaged, leading to deteriorated durability of the injector.

In the fuel circulation apparatus in Patent Document 1 provided with such injectors (a first injector and a second injector) in the fuel injection unit for injecting gas fuel, the first injector and the second injector are almost alternately caused to inject gas fuel with temporal phases. This may increase the number of injections of the first injector and the second injector, resulting in deteriorated durability of the first injector and the second injector. In the fuel circulation apparatus in Patent Document, consequently, the life of the fuel injection unit for injecting gas fuel may be decreased.

The present disclosure has been made to address the above problems and has a purpose to provide a fuel supply apparatus capable of enhancing the life of a fuel injection unit for injecting gas fuel to be supplied to a fuel cell.

### Means of Solving the Problems

To achieve the above-mentioned purpose, one aspect of the present disclosure provides a fuel supply apparatus comprising: a fuel injection unit configured to inject gas fuel to be supplied to a fuel cell; and an injection control unit configured to control the fuel injection unit, wherein the fuel injection unit includes: a first fuel injection valve having an injection port for the gas fuel and being configured to maintain an opening degree of the injection port at a predetermined opening degree between a fully closed opening degree and a fully open opening degree to inject the gas fuel; and a second fuel injection valve configured to intermittently inject the gas fuel, and the injection control unit is configured to control actuation of the first fuel injection valve and actuation of the second fuel injection valve in coordination.

According to the above configuration, the fuel injection unit includes the first fuel injection valve. Herein, the first fuel injection valve is configured to maintain the opening degree of the injection port for the gas fuel at a predetermined opening degree (an intermediate opening degree) defined between a fully closed opening degree and a fully open opening degree to inject the gas fuel. Thus, when the first fuel injection valve is actuated to inject the gas fuel, the present configuration can reduce the number of times a valve element and a valve seat strike each other to open and close the injection port for gas fuel of the first fuel injection valve. This can suppress deterioration of the durability of the valve element and the valve seat. Thus, the first fuel injection valve can maintain its durability, resulting in enhanced life of the fuel injection unit.

Furthermore, actuating the first fuel injection valve can lead to a reduction in the number of actuations of the second fuel injection valve. Thus, the second fuel injection valve can maintain its durability, enabling to enhance the life of the fuel injection unit.

In the foregoing aspect, preferably, the injection control unit is configured to perform a first-injection-valve injection control to actuate the first fuel injection valve but stop the second fuel injection valve during low output of the fuel cell in which a change rate of output of the fuel cell is less than a predetermined amount.

According to the above configuration, the second fuel injection valve is stopped during low output of the fuel cell. This configuration can more effectively maintain the durability of the second fuel injection valve.

In the foregoing aspect, preferably, during the first-injection-valve injection control, the injection control unit performs the control so that an actual pressure of an inner pressure of the fuel cell becomes a lower limit of a target pressure.

According to the above configuration, the injection amount of the gas fuel from the first fuel injection valve can be suppressed, so that the fuel consumption of the fuel cell can be enhanced.

In the foregoing aspect, preferably, the injection control unit is configured to perform a double-injection-valve injection control to actuate both the first fuel injection valve and the second fuel injection valve during high output of the fuel cell in which a change rate of output of the fuel cell is more than a predetermined amount.

According to the above configuration, during the high output of the fuel cell, even when actuation of only the first fuel injection valve could not satisfy the requested injection amount of gas fuel, it is possible to satisfy the requested injection amount of gas fuel by actuation of the second fuel injection valve in addition to the first fuel injection valve.

In the foregoing aspect, preferably, during the double-injection-valve injection control, the injection control unit performs a feedback control to control an injection amount of the gas fuel to be injected by the second fuel injection valve according to a difference between a requested injection amount of the gas fuel and an injection amount of the gas fuel injected by the first fuel injection valve.

According to the above configuration, during the high output of the fuel cell, the requested injection amount of gas fuel can be satisfied more reliably.

In the foregoing aspect, preferably, during the high output of the fuel cell, the injection control unit is configured to perform: the double-injection-valve injection control when a pressure difference between a target pressure and an actual pressure of an inner pressure of the fuel cell is larger than a pressure difference allowing pressure increase of the actual pressure by actuation of the first fuel injection valve, and the first-injection-valve injection control to actuate the first fuel injection valve but stop the second fuel injection valve when the pressure difference between the target pressure and the actual pressure of the fuel cell is equal to or less than the pressure difference allowing pressure increase of the actual pressure by actuation of the first fuel injection valve.

According to the above configuration, during the high output of the fuel cell, if the inner pressure of the fuel cell could not be adjusted to the target pressure by actuating only the first fuel injection valve, the injection control unit drives the second fuel injection valve together with the first fuel injection valve. This can make sure that the inner pressure of the fuel cell reaches the target pressure. During the high output of the fuel cell, furthermore, if the inner pressure of the fuel cell could be adjusted to the target pressure by just actuating the first fuel injection valve, the injection control unit drives only the first fuel injection valve and stops the second fuel injection valve. Accordingly, the above configuration can reduce a difference between the inner pressure of the fuel cell on a gas fuel side and the inner pressure of the same on an air side while suppressing the generation of pulsation of the inner pressure of the fuel cell. In the fuel cell, therefore, the fuel is less likely to pass from the gas fuel side to the air side, so that the fuel consumption of the fuel cell can be enhanced.

The foregoing aspect preferably further includes an ejector provided in a position downstream of the fuel injection unit and upstream of the fuel cell, wherein the ejector is configured to introduce the gas fuel injected from the fuel injection unit, generating a negative pressure, suck fuel offgas exhausted from the fuel cell by use of the negative pressure, merge the sucked fuel offgas with the introduced gas fuel, and circulate to the fuel cell, and an introduction port of the ejector for the gas fuel is connected to an injection port of the first fuel injection valve for the gas fuel.

According to the above configuration, even when only the first fuel injection valve is actuated, the ejector can circulate the fuel offgas exhausted from the fuel cell to the fuel cell, so that the circulation function of fuel offgas by the ejector can be maintained.

In the foregoing aspect, preferably, the injection control unit is configured to cause the fuel injection unit to intermittently inject the gas fuel when a freezing generation condition that freezing occurs inside the ejector is satisfied during execution of the first-injection-valve injection control in which the first fuel injection valve is actuated but the second fuel injection valve is stopped.

According to the above configuration, the ejector intermittently injects the gas fuel to cause pulsation of the gas fuel in the ejector, thereby preventing freezing or icing inside the ejector.

In the foregoing aspect, preferably, the first fuel injection valve is a fuel injection valve configured to open and close the injection port for the gas fuel by actuation of by a linear actuator.

According to the above configuration, actuation of the linear actuator can reliably maintain the opening degree of the injection port of the first fuel injection valve at the predetermined opening degree.

### Effects of the Invention

According to a fuel supply apparatus of the present disclosure, it is possible to enhance the life of a fuel injection unit for injecting gas fuel to be supplied to a fuel cell.

### BRIEF DESCRIPTION OF THE DRAWINGS

FIG. 1 is a diagram showing a schematic configuration of a fuel cell system provided with a fuel supply apparatus in a present embodiment;

FIG. 2 is a graph showing actuation or non-actuation of a linear solenoid valve and an injector, stack inner pressure, and stack output, when the stack output less changes in the present embodiment;

FIG. 3 is a flowchart showing control contents to be performed by an injection control unit in the present embodiment;

FIG. 4 is a graph showing actuation or non-actuation of the linear solenoid valve and the injector, stack inner pressure, and stack output, when the stack output greatly changes in the present embodiment;

FIG. 5 is a chart showing injection timings of the linear solenoid valve and the injector;

FIG. 6 is a graph showing a map that defines a relationship between tank internal temperature, ambient temperature, and time;

FIG. 7 is a diagram showing a first modified example related to connection between a fuel injection unit and an ejector;

FIG. 8 is a diagram showing a second modified example related to connection between the fuel injection unit and the ejector;

FIG. 9 is a diagram showing a third modified example related to connection between the fuel injection unit and the ejector;

FIG. 10 is a graph showing stack inner pressure and stack output by actuation of only an injector when the stack output less changes; and

FIG. 11 is a graph showing stack inner pressure and stack output by actuation of only a linear solenoid when the stack output greatly changes.

### MODE FOR CARRYING OUT THE INVENTION

A detailed description of an embodiment of a fuel supply apparatus in the present disclosure will now be given referring to the accompanying drawings.

<Outline of Fuel Cell System>

The outline of a fuel cell system provided with the fuel supply apparatus in the present embodiment will be described first below. This fuel cell system 1 is a system to be mounted in a fuel cell vehicle and operated to supply electric power to a driving motor (not shown) of the vehicle.

(Schematic Configuration of Fuel Cell System)

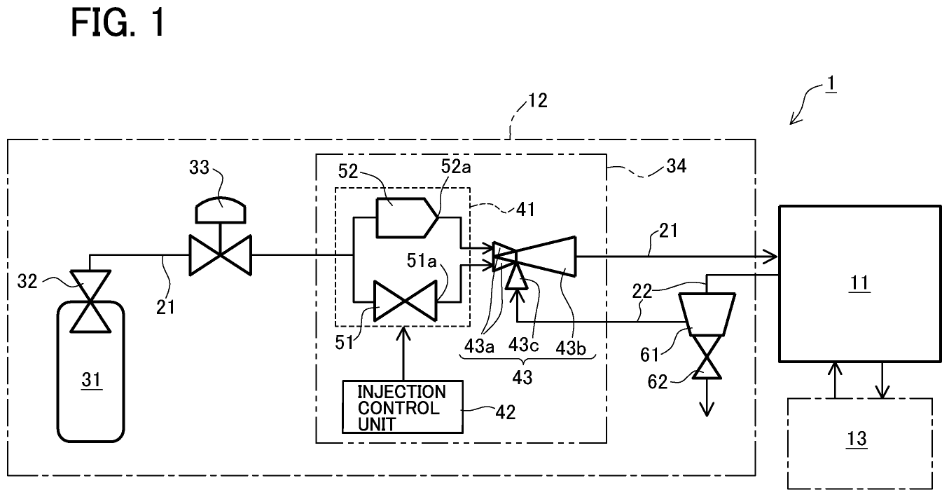

The fuel cell system 1 includes, as shown in FIG. 1, an FC stack (a fuel cell) 11, a hydrogen system 12, and an air system 13.

The FC stack 11 is configured to generate electric power upon receipt of supply of fuel gas and supply of oxidant gas. In the present embodiment, the fuel gas is hydrogen gas and the oxidant gas is air. That is, the FC stack 11 generates electric power when receiving the hydrogen gas supplied from the hydrogen system 12 and the air supplied from the air system 13. The electric power generated in the FC stack 11 is supplied to the driving motor (not shown) through an inverter (not shown).

The hydrogen system 12 is provided on an anode side of the FC stack 11. This hydrogen system 12 is provided with a hydrogen supply passage 21 and a hydrogen offgas circulation passage 22. The hydrogen supply passage 21 is a passage configured to supply hydrogen gas from a hydrogen tank 31 to the FC stack 11. The hydrogen offgas circulation passage 22 is a passage configured to circulate hydrogen gas exhausted from the FC stack 11 (hereinafter, appropriately referred to as hydrogen offgas).

The hydrogen system 12 is provided with a main stop valve 32, a pressure reducing valve 33, and a fuel supply apparatus 34, which are arranged in the hydrogen supply passage 21, in this order from the hydrogen tank 31 side. The main stop valve 32 is a valve configured to switch between supply and shutoff of hydrogen gas from the hydrogen tank 31 to the hydrogen supply passage 21. The pressure reducing valve 33 is a pressure regulating valve to reduce the pressure of hydrogen gas.

The fuel supply apparatus 34 is an apparatus configured to supply hydrogen gas (one example of gas fuel in the present disclosure) to the FC stack 11 and includes a fuel injection unit 41, an injection control unit 42, and an ejector 43.

The fuel injection unit 41 is a mechanism for injecting hydrogen gas to be supplied to the FC stack 11. In the present embodiment, the fuel injection unit 41 serves as a valve for injecting hydrogen gas and thus includes a linear solenoid valve 51 (a first fuel injection valve) and an injector 52 (a second fuel injection valve). In the example shown in FIG. 1, the linear solenoid valve 51 and the injector 52 are arranged in parallel.

The linear solenoid valve 51 is a valve configured to open and close an injection port 51a for hydrogen gas by actuation of a linear solenoid (not shown, one example of a linear actuator in the present disclosure). This linear solenoid valve 51 is an injection amount regulating valve (a flow rate regulating valve) configured to be controlled to maintain the opening degree of the injection port 51a at a predetermined opening degree defined between a fully closed opening degree (100% opening degree) and a fully open opening degree (0% opening degree) to regulate an injection amount (a flow rate) of hydrogen gas to a predetermined amount. The “predetermined opening degree” indicates a value to be changed according to an operating condition and the “predetermined amount” indicates an amount corresponding to a requested power generation amount.

The injector 52 is an on-off valve configured to be controlled to switch the opening degree of the injection port 52a only to either a fully closed opening degree or a fully open opening degree to intermittently inject hydrogen gas. The injection amount of the injector 52 is set to be smaller than the injection amount of the linear solenoid valve 51.

The injection control unit 42 is provided with for example a CPU and memories such as a ROM and a RAM and configured to control the fuel injection unit 41 based on programs stored in advance in the memories.

The ejector 43 is placed in a position downstream of the fuel injection unit 41 (i.e., on a downstream side in a flowing direction of hydrogen gas flowing through the hydrogen supply passage 21) and upstream of the FC stack 11 (i.e., on an upstream side in the flowing direction of hydrogen gas flowing through the hydrogen supply passage 21). The ejector 43 includes an inlet 43a, an outlet 43b, and a suction port 43c.

The inlet 43a is an inflow port for hydrogen gas to be injected from the fuel injection unit 41. In the example shown in FIG. 1, this inlet 43a is connected to the injection port 51a of the linear solenoid valve 51 and the injection port 52a of the injector 52. The outlet 43b is configured to exhaust hydrogen gas and connected to the FC stack 11. Furthermore, the suction port 43c is configured to suck hydrogen offgas (fuel offgas) and connected to the hydrogen offgas circulation passage 22.

The ejector 43 is configured to introduce therein the hydrogen gas injected from the fuel injection unit 41 through the inlet 43a, generating a negative pressure, suck the hydrogen offgas, which is exhausted from the FC stack 11 to the hydrogen offgas circulation passage 22, through the suction port 43c by use of the negative pressure generated in the ejector 43. The ejector 43 is further configured to merge the hydrogen offgas sucked through the suction port 43c with the hydrogen gas introduced therein through the inlet 43a and then return this merged gas to the FC stack 11 through the outlet 43b. In this manner, the hydrogen offgas exhausted from the FC stack 11 to the hydrogen offgas circulation passage 22 is circulated to the FC stack 11 through the ejector 43.

The hydrogen system 12 includes a gas-liquid separator 61 and an exhaust-drain valve 62 arranged in the hydrogen offgas circulation passage 22 for circulating hydrogen offgas from the FC stack 11 to the ejector 43. The gas-liquid separator 61 is a device configured to separate water or moisture from the hydrogen offgas. The gas-liquid separator 61 is connected to the suction port 43c of the ejector 43 through the hydrogen offgas circulation passage 22. The exhaust-drain valve 62 is a switch valve configured to switch between exhaust and shutoff of hydrogen offgas and water from the gas-liquid separator 61 to a dilutor (not shown) of the air system 13.

(Operations of Fuel Cell System)

In the fuel cell system 1 configured as above, the hydrogen system 12 is configured to supply the hydrogen gas to the FC stack 11 through the hydrogen supply passage 21, and the hydrogen gas is used in the FC stack 11 to generate electric power and then sucked as hydrogen offgas from the FC stack 11 into the ejector 43 through the hydrogen offgas circulation passage 22 or exhausted out. The air system 13 is configured to supply air to the FC stack 11, and the air is used in the FC stack 11 to generate electric power and then exhausted out as air offgas from the FC stack 11.

(Coordination Control of Linear Solenoid Valve and Injector)

In the fuel supply apparatus 34 in the present embodiment, the injection control unit 42 controls actuation of the linear solenoid valve 51 (injection of hydrogen gas by the linear solenoid valve 51) and actuation of the injector 52 (injection of hydrogen gas by the injector 52) in coordination, or cooperatively. Therefore, the following description is given to the coordination control of the linear solenoid valve 51 and the injector 52 in the present embodiment.

<The Case where Stack Output Less Changes>

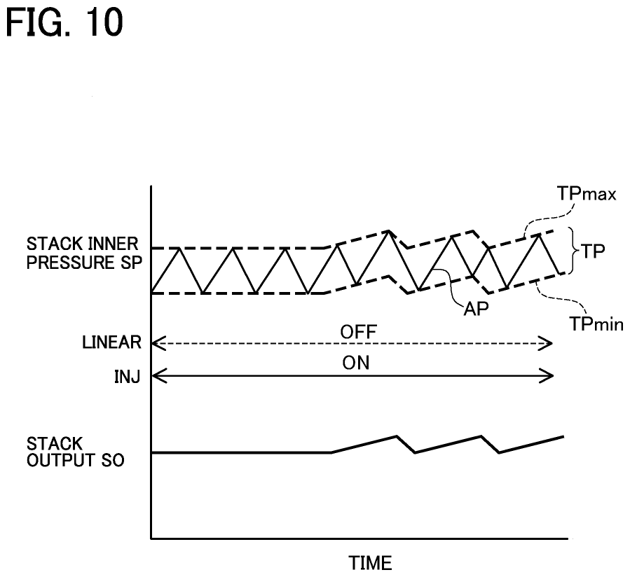

When a vehicle mounted with the fuel cell system 1 is in steady running or in slow accelerating, etc., as shown in FIG. 10, the stack output SO (output of the FC stack 11) less changes. At that time, specifically, a change rate (a variation) of the stack output SO is less than a predetermined amount X. This condition that the stack output SO less changes means that the change rate of power generation in the FC stack 11 less changes. Assuming that a maximum stack output SO is 100%, the predetermined amount X is for example 20%.

Herein, the following case is assumed. That is, when the change in stack output SO is small (i.e., during low output of the fuel cell), the linear solenoid valve 51 (LINEAR) is stopped, i.e., the linear solenoid valve 51 is stopped from injecting hydrogen gas, and only the injector 52 (INJ) is actuated as shown in FIG. 10. Since the injector 52 is an on-off valve and is configured to intermittently inject hydrogen gas, the stack inner pressure SP (the inner pressure of the FC stack 11) greatly pulsates as shown in FIG. 10. Accordingly, the amount of hydrogen gas to be supplied to the FC stack 11 is not stable and thus the fuel consumption of the FC stack 11 may lower. Further, the number of times the injector 52 is actuated (i.e., the number of injections) increases, so that the durability of the injector 52 may deteriorate.

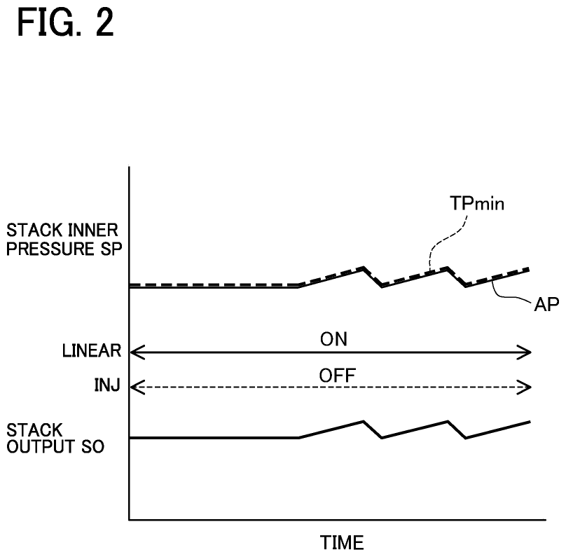

In the present embodiment, therefore, as shown in FIG. 2, when the change in stack output SO is small, the injection control unit 42 performs control to actuate the linear solenoid valve 51 and stop the injector 52 (First-injection-valve injection control). At that time, the injection control unit 42 maintains the opening degree of the injection port 51a of the linear solenoid valve 51 at a predetermined opening degree between a fully closed opening degree and a fully open opening degree to adjust the actual pressure AP of the stack inner pressure SP to a lower limit TPmin of the target pressure-regulation value. Accordingly, as shown in FIG. 2, the actual pressure AP of the stack inner pressure SP is controlled to the lower limit TPmin of the target pressure-regulation value. Thus, the stack inner pressure SP is suppressed from generating pulsations, thereby reducing a difference between the inner pressure of the FC stack 11 on the hydrogen gas side and the inner pressure of the same on the air side, so that the fuel consumption of the FC stack 11 is enhanced.

Furthermore, since the injector 52 is stopped, the number of actuations of the injector 52 can be reduced. Accordingly, the durability of the injector 52 can be maintained and thus the life of the fuel injection unit 41 can be enhanced.

<The Case where Stack Output Greatly Changes>

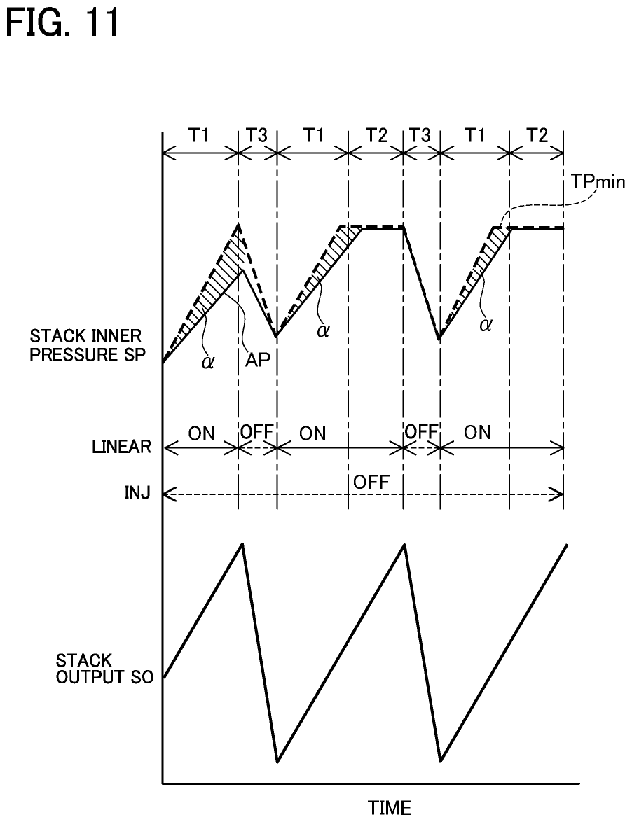

On the other hand, when a vehicle mounted with the fuel cell system 1 is in rapid accelerating (during WOT (WIDE OPEN THROTTLE)), as shown in FIG. 11, the stack output SO greatly changes. At that time, specifically, a change rate of the stack output SO is equal to or more than the predetermined amount X. This condition that the stack output SO greatly changes means that the change rate of power generation in the FC stack 11 largely changes.

Herein, the following case is assumed. That is, when the change in stack output SO is large (i.e., during high output of the fuel cell), the injector 52 is stopped and only the linear solenoid valve 51 is actuated as shown in FIG. 11. At that time, actuation of the linear solenoid valve 51 is controlled so that the actual pressure AP of the stack inner pressure SP becomes the lower limit TPmin of the target pressure-regulation value. Since the linear solenoid valve 51 has a low response to inject hydrogen gas, however, a region a in which the actual pressure AP of the stack inner pressure SP cannot reach the lower limit TPmin of the target pressure-regulation value may occur in a time period T1 in which the target pressure-regulation value TP of the stack inner pressure SP increases as shown in FIG. 11.

In the present embodiment, therefore, when the change in stack output SO is large, the injection control unit 42 actuates the linear solenoid valve 51 and, as needed, also actuates the injector 52.

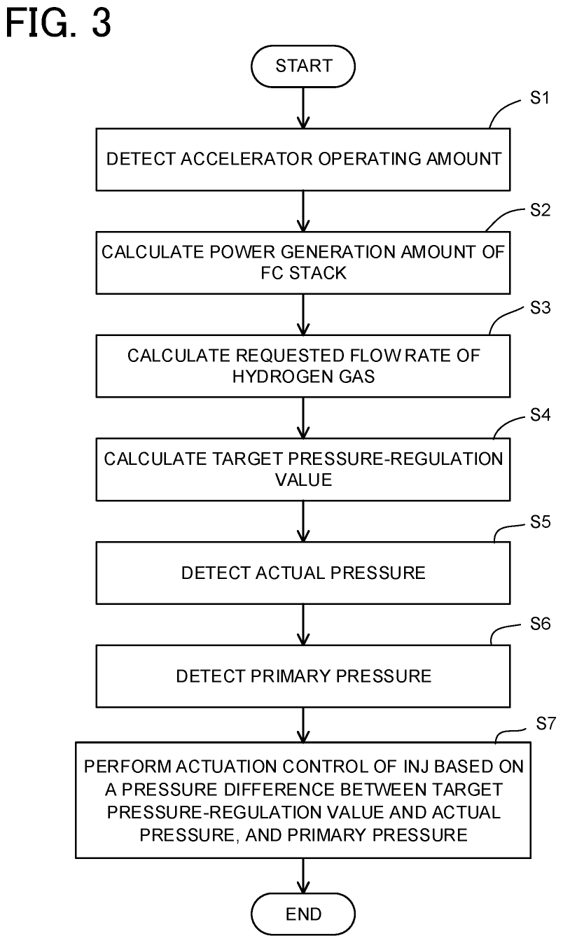

To be concrete, the injection control unit 42 performs the control contents shown in a flowchart of FIG. 3. As shown in FIG. 3, the injection control unit 42 detects an accelerator operating amount (i.e., a depression amount of an accelerator pedal (not shown)) (step S1) and then calculates a power generation amount of a FC stack (a required power generation amount of the FC stack 11) based on the detected accelerator operating amount (step S2). Successively, the injection control unit 42 calculates a requested hydrogen flow rate (a requested flow rate of hydrogen gas to be supplied to the FC stack 11) based on the calculated power generation amount of the FC stack (step S3). Then, the injection control unit 42 calculates a target pressure-regulation value TP of the stack inner pressure SP based on the calculated requested hydrogen flow rate (step S4) and also detects the actual pressure AP and a primary pressure (i.e., the pressure on the upstream side of the fuel supply apparatus 34) (steps S5 and S6).

The injection control unit 42 subsequently performs actuation control of the injector 52 (INJ) based on a pressure difference between the target pressure-regulation value TP and the actual pressure AP and also the primary pressure (step S7).

In this step S7, when the pressure difference between the target pressure-regulation value TP and the actual pressure AP is equal to or less than a pressure difference allowing pressure increase of the actual pressure AP by actuation of the linear solenoid valve 51, the injection control unit 42 controls actuation of the linear solenoid valve 51 and stop the injector 52 (the first-injection-valve injection control). In other words, when the stack inner pressure SP can be adjusted to the target pressure-regulation value TP by actuation of the linear solenoid valve 51, the injection control unit 42 stops the injector 52 and actuates only the linear solenoid valve 51.

In contrast, when the pressure difference between the target pressure-regulation value TP and the actual pressure AP is larger than the pressure difference allowing pressure increase of the actual pressure AP by actuation of the linear solenoid valve 51, the injection control unit 42 performs control to actuate the linear solenoid valve 51 and also actuate the injector 52 (Double-injection-valve injection control). In other words, when the stack inner pressure SP cannot be adjusted to the target pressure-regulation value TP even by actuation of the linear solenoid valve 51, the injection control unit 42 actuates both the linear solenoid valve 51 and the injector 52.

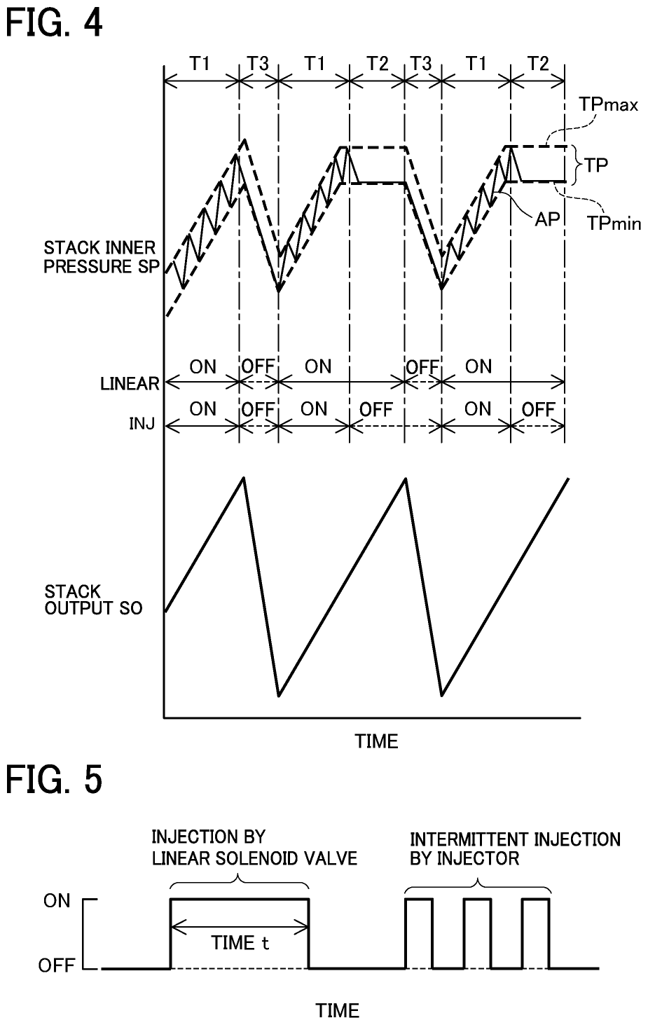

The injection control unit 42 executes the control contents shown in the flowchart of FIG. 3 to perform such a control as shown in FIG. 4.

As shown in FIG. 4, in the time period T1 in which the target pressure-regulation value TP of the stack inner pressure SP increases, the injection control unit 42 performs the double-injection-valve injection control. In this time period T1, a change value (an increase value) of the target pressure-regulation value TP per unit time is larger than a predetermined value and the pressure difference between the target pressure-regulation value TP and the actual pressure AP is larger than the pressure difference allowing pressure increase of the actual pressure AP by actuation of the linear solenoid valve 51.

When the change in stack output SO is large, as described above, the injection control unit 42 performs the double-injection-valve injection control to enhance output response of the fuel injection unit 41 so as to address a request for rapid increase of the stack inner pressure SP.

During the double-injection-valve injection control executed as described above, the injection control unit 42 performs a feedback control to control the injection amount of hydrogen gas to be injected by the injector 52 according to a difference between the requested injection amount of hydrogen gas and the injection amount of hydrogen gas injected by the linear solenoid valve 51. At that time, the injection control unit 42 controls actuation of the injector 52 so that a pulsation range of the stack inner pressure SP generated by actuation of the injector 52 falls within a range defined by an upper limit TPmax and a lower limit TPmin of the target pressure.

In a time period T2 in which the target pressure-regulation value TP of the stack inner pressure SP is constant, as shown in FIG. 4, the injection control unit 42 performs the control to stop the injector 52 and actuate only the linear solenoid valve 51 (the first-injection-valve injection control). In this time period T2, the change value (the increase value) of the target pressure-regulation value TP per unit time is equal to or less than the predetermined value and the pressure difference between the target pressure-regulation value TP and the actual pressure AP is equal to or less than the pressure difference allowing pressure increase of the actual pressure AP by actuation of the linear solenoid valve 51.

When the target pressure-regulation value TP of the stack inner pressure SP is constant (i.e., during constant pressure), the injection control unit 42 actuates the linear solenoid valve 51 to adjust the stack inner pressure SP to the lower limit TPmin of the target pressure-regulation value. The injection control unit 42 stops the injector 52 to suppress the generation of pulsation of the stack inner pressure SP. This can reduce the amount of hydrogen gas to be supplied to the FC stack 11 to a requisite minimum and also reduce a difference between the inner pressure of the FC stack 11 on the hydrogen gas side and the inner pressure of the same on the air side. Thus, the fuel consumption of the FC stack 11 can be enhanced.

Since the injector 52 is stopped, the number of actuations of the injector 52 can be reduced. Accordingly, the durability of the injector 52 can be maintained and hence the life of the fuel injection unit 41 can be enhanced.

In a time period T3 in which the target pressure-regulation value TP of the stack inner pressure SP decreases, as shown in FIG. 4, the injection control unit 42 stops both the linear solenoid valve 51 and the injector 52.

<Control to Prevent Internal Freezing of the Ejector>

When the outside air temperature and the inside temperature of the hydrogen tank 31 are low, such as during a subfreezing condition or a continuous steady running of a vehicle, the temperature of hydrogen gas to be supplied from the hydrogen tank 31 to the fuel supply apparatus 34 is low. In contrast, when the FC stack 11 is warmed after starting of the vehicle, hydrogen offgas to be circulated from the FC stack 11 to the ejector 43 through the hydrogen offgas circulation passage 22 comes into a warm and wet state.

When the temperature of hydrogen gas to be supplied to the fuel supply apparatus 34 is low whereas the hydrogen offgas circulated to the ejector 43 is in the warm and wet state, frost may form on a merging area in the ejector 43 (a nozzle and a diffuser) where the hydrogen gas and the hydrogen offgas merge each other. At that time, when the linear solenoid valve 51 is operated to inject hydrogen gas with the injection port 51a opened with an opening degree maintained at a predetermined opening degree while the injector 52 is stopped, the pulsation of hydrogen gas flowing through the inside of the ejector 43 is small. Thus, frost may form inside the ejector 43 and further gradually grow into ice, resulting in freezing.

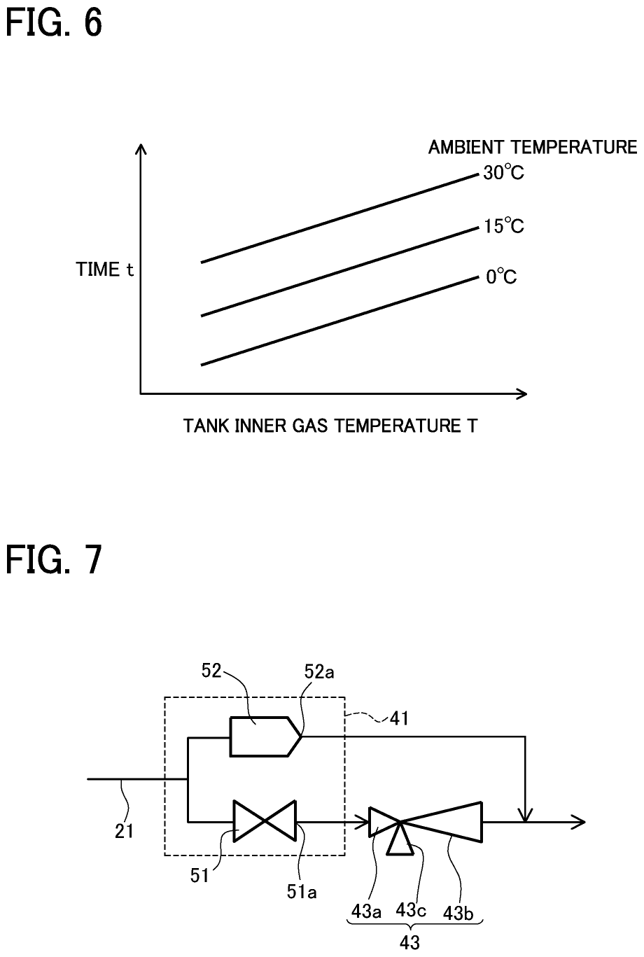

Thus, in the case where frost may form inside the ejector 43 as described above, when the injection control unit 42 actuates the linear solenoid valve 51 to continuously inject hydrogen gas, the injection control unit 42 also causes the injector 52 to intermittently inject hydrogen gas at least once or more after a lapse of a time t (a predetermined time) (see FIG. 5). Herein, the time t is set to a time in which the frost having formed inside the ejector 43 will not freeze. For example, as shown in FIG. 6, this is defined on a map based on a tank inside gas temperature T (the inside temperature of the hydrogen tank 31) and an ambient temperature (an outside temperature). The time t is defined to be longer as the tank inside gas temperature T and the ambient temperature are higher as shown in FIG. 6.

While performing the first-injection-valve injection control by actuating the linear solenoid valve 51 and stopping the injector 52 as above, the injection control unit 42 determines that a freezing generation condition that freezing occurs inside the ejector 43 is satisfied after a lapse of the time t by referring to the map in FIG. 6. When determines that the freezing generation condition is satisfied, the injection control unit 42 performs a second-injection-valve injection control to stop the linear solenoid valve 51 and actuate the injector 52 to intermittently inject hydrogen gas from the fuel injection unit 41 to cause pulsation of the hydrogen gas in the ejector 43. This operation can vibrate and blow away the frost having formed inside the ejector 43, thereby preventing freezing from occurring inside the ejector 43.

### Operations and Effects in the Present Embodiment

In the fuel supply apparatus 34 in the present embodiment described above, the fuel injection unit 41 includes the linear solenoid valve 51 and the injector 52. The injection control unit 42 controls actuation of the linear solenoid valve 51 and actuation of the injector 52 in coordination.

The fuel injection unit 41 includes the linear solenoid valve 51 as above. Herein, the linear solenoid valve 51 is configured to maintain the opening degree of the injection port 51a at a predetermined opening degree (an intermediate opening degree) between the fully closed opening degree and the fully open opening degree to inject hydrogen gas. Accordingly, during actuation of the linear solenoid valve 51, it is possible to reduce the number of times a valve (a valve element not shown) and a seat part (a valve seat not shown) for opening and closing the injection port 51a of the linear solenoid valve 51 strike each other, so that the durability of the valve and the seat part can be prevented from deteriorating. Accordingly, the durability of the linear solenoid valve 51 can be maintained and thus the life of the fuel injection unit 41 can be enhanced.

Since the linear solenoid valve 51 is actuated, the number of actuations of the injector 52 can be reduced. Accordingly, the durability of the linear solenoid valve 51 can be maintained and thus the life of the fuel injection unit 41 can be enhanced.

When the stack output SO less changes (i.e., during low output of the fuel cell), the injection control unit 42 performs the control to actuate the linear solenoid valve 51 while stopping the injector 52 (the first-injection-valve injection control).

Since the injector 52 is stopped when the change of the stack output SO is small, the durability of the injector 52 can be maintained more effectively. Furthermore, since the linear solenoid valve 51 is actuated, the fuel consumption of the FC stack 11 can be enhanced.

During the first-injection-valve injection control, the injection control unit 42 performs this control so that the stack inner pressure SP becomes the lower limit TPmin of the target pressure-regulation value.

This can reduce the injection amount of hydrogen gas to be injected by the linear solenoid valve 51 and thus enhance the fuel consumption of the FC stack 11.

When the stack output SO changes greatly (i.e., during high output of the fuel cell), the requested injection amount (the injection amount of hydrogen gas requested from the FC stack 11) is large and thus the requested injection amount may not be satisfied by actuation of only the linear solenoid valve 51.

When the change of the stack output SO is large, therefore, the injection control unit 42 performs the control to drive the linear solenoid valve 51 and also drive the injector 52 (the double-injection-valve injection control).

Even when the requested injection amount could not be satisfied by actuation of only the linear solenoid valve 51 while the stack output SO greatly varies, the requested injection amount can be satisfied by actuation of both the linear solenoid valve 51 and the injector 52.

During the double-injection-valve injection control, the injection control unit 42 performs the feedback control to regulate the injection amount of hydrogen gas to be injected by the injector 52 according to a difference between the requested injection amount and the injection amount of hydrogen gas injected by the linear solenoid valve 51.

It is therefore possible to satisfy the requested injection amount more reliably while the stack output SO changes greatly.

During high output of the fuel cell, when the pressure difference between the target pressure-regulation value TP and the actual pressure AP of the inner pressure of the FC stack 11 is larger than the pressure difference allowing pressure increase of the actual pressure AP by actuation of the linear solenoid valve 51, the injection control unit 42 performs the double-injection-valve injection control. Further, during high output of the fuel cell, when the pressure difference between the target pressure-regulation value TP and the actual pressure AP of the inner pressure of the FC stack 11 is equal to or less than the pressure difference allowing pressure increase of the actual pressure AP by actuation of the linear solenoid valve 51, the injection control unit 42 performs the first-injection-valve injection control.

When the stack inner pressure SP could not be adjusted to the target pressure-regulation value TP by actuation of only the linear solenoid valve 51 during high output of the fuel cell, the injection control unit 42 actuates the injector 52 in addition to the linear solenoid valve 51. This makes sure that the stack inner pressure SP is adjusted to the target pressure-regulation value TP.

During high output of the fuel cell, when the stack inner pressure SP can be adjusted to the target pressure-regulation value TP by actuation of only the linear solenoid valve 51, the injection control unit 42 actuates only the linear solenoid valve 51 and stops the injector 52. This makes it possible to reduce a difference between the inner pressure of the FC stack 11 on the hydrogen gas side and the inner pressure of the same on the air side while preventing the stack inner pressure SP from pulsating. Accordingly, excess hydrogen gas is less likely to pass to the FC stack 11, so that the fuel consumption of the FC stack 11 can be enhanced. Since the injector 52 is stopped, the number of actuations of the injector 52 can be reduced. Accordingly, the durability of the injector 52 can be maintained and thus the life of the fuel injection unit 41 can be enhanced.

The inlet 43a of the ejector 43 is connected to the injection port 51a of the linear solenoid valve 51.

Even when only the linear solenoid valve 51 is actuated in the above manner as in the first-injection-valve injection control, the ejector 43 can circulate the hydrogen offgas to the FC stack 11. Thus, the circulation function of hydrogen offgas by the ejector 43 can be maintained.

The inlet 43a of the ejector 43 is also connected to the injection port 52a of the injector 52. When the freezing generation condition that freezing occurs inside the ejector 43 is satisfied during execution of the first-injection-valve injection control in which the linear solenoid valve 51 is actuated but the injector 52 is stopped, the injection control unit 42 may actuate the injector 52 to intermittently inject hydrogen gas from the fuel injection unit 41.

This intermittent injection of hydrogen gas causes pulsation of the hydrogen gas in the ejector 43, thereby preventing freezing inside the ejector 43.

The foregoing embodiments are mere examples and give no limitation to the present disclosure. The present disclosure may be embodied in other specific forms without departing from the essential characteristics thereof.

For instance, the injection control unit 42 may be configured to actuate the injector 52 when the circulation flow rate of hydrogen offgas by the ejector 43 is not sufficient in the first-injection-valve injection control.

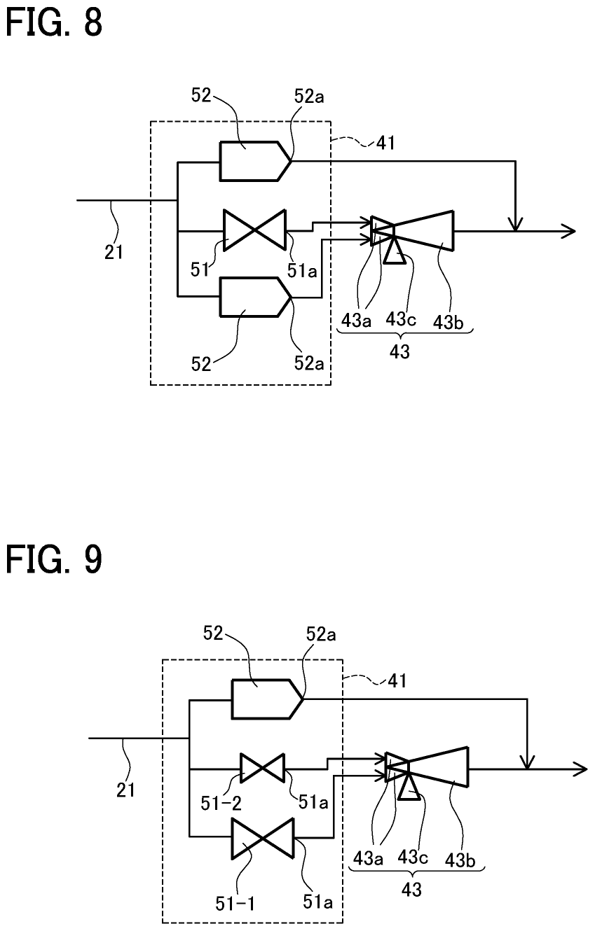

The inlet 43a of the ejector 43 has only to be connected to at least one of the injection port 51a of the linear solenoid valve 51 and the injection port 52a of the injector 52. For example, as shown in FIG. 7, the inlet 43a of the ejector 43 may be connected to the injection port 51a of the linear solenoid valve 51, but not connected to the injection port 52a of the injector 52. As shown in FIG. 8, as an alternative, when two injectors 52 are provided, the inlet 43a of the ejector 43 may be connected to the injection port 51a of the linear solenoid valve 51 and an injection port 52a of one of the injectors 52, but not connected to an injection port 52a of the other injector 52.

As shown in FIG. 9, as an alternative, the inlet 43a of the ejector 43 may be connected to an injection port 51a of a large linear solenoid valve 51-1 (a first linear solenoid valve) and an injection port 51a of a small linear solenoid valve 51-2 (a second linear solenoid valve), but not connected to the injection port 52a of the injector 52. Herein, the injection amount of hydrogen gas to be injected by the large linear solenoid valve 51-1 is larger than the injection amount of hydrogen gas to be injected by the small linear solenoid valve 51-2. During high output of the fuel cell, the injection control unit 42 performs the control to actuate the large linear solenoid valve 51-1 but stop the small linear solenoid valve 51-2. When the injection amount of hydrogen gas by the linear solenoid valve 51-1 is insufficient, the injection control unit 42 performs the control to actuate the injector 52 in addition to the linear solenoid valve 51-1.

As the fuel injection valve (the first fuel injection valve) capable of controlling the opening degree of the injection port for hydrogen gas to the predetermined opening degree between the fully closed opening degree and the fully open opening degree, a valve to be actuated by a linear electromagnetic actuator (e.g., an injector to be actuated by a linear solenoid) or a valve to be actuated by a piezoelectric actuator may be used instead of the linear solenoid valve 51.

The injection amount of the injector 52 and the injection amount of the linear solenoid valve 51 may be set to the same amount.

The injection control unit 42 may be configured to cause the fuel injection unit 41 to intermittently inject hydrogen gas when the foregoing freezing generation condition is satisfied. When the freezing generation condition is satisfied, therefore, the injection control unit 42 may actuate the injector 52 while actuating the linear solenoid valve 51 or may actuate only the linear solenoid valve 51 to intermittently hydrogen gas from the fuel injection unit 41.

Furthermore, instead of the injector 52, a second (another) linear solenoid valve 51 (one example of the second fuel injection valve in the present disclosure) may be provided, so that the injection control unit 42 actuates the second linear solenoid valve 51 when the foregoing freezing generation condition is satisfied, thereby intermittently injecting hydrogen gas from the fuel injection unit 41.

### REFERENCE SIGNS LIST

1 Fuel cell system
11 FC stack
12 Hydrogen system
21 Hydrogen supply passage
22 Hydrogen offgas circulation passage
31 Hydrogen tank
34 Fuel supply apparatus
41 Fuel injection unit
42 Injection control unit
43 Ejector
43a Inlet
43b Outlet
43c Suction port
51 Linear solenoid valve
51a Injection port
52 Injector
52a Injection port
SO Stack output
SP Stack inner pressure
TP Target pressure-regulation value
TPmin Lower limit of target pressure-regulation value
TPmax Upper limit of target pressure-regulation value
AP Actual pressure
α Region
T1, T2, T3 Time period
T Tank inner gas temperature
t Time

1. A fuel supply apparatus comprising:
a fuel injection unit configured to inject gas fuel to be supplied to a fuel cell; and
an injection control unit configured to control the fuel injection unit,
wherein the fuel injection unit includes:
a first fuel injection valve having an injection port for the gas fuel and being configured to maintain an opening degree of the injection port at a predetermined opening degree between a fully closed opening degree and a fully open opening degree to inject the gas fuel; and
a second fuel injection valve configured to intermittently inject the gas fuel, and
the injection control unit is configured to control actuation of the first fuel injection valve and actuation of the second fuel injection valve in coordination.

2. The fuel supply apparatus according to claim 1, wherein the injection control unit is configured to perform a first-injection-valve injection control to actuate the first fuel injection valve but stop the second fuel injection valve during low output of the fuel cell in which a change rate of output of the fuel cell is less than a predetermined amount.

3. The fuel supply apparatus according to claim 2, wherein,
during the first-injection-valve injection control, the injection control unit performs the control so that an actual pressure of an inner pressure of the fuel cell becomes a lower limit of a target pressure.

4. The fuel supply apparatus according to claim 1, wherein the injection control unit is configured to perform a double-injection-valve injection control to actuate both the first fuel injection valve and the second fuel injection valve during high output of the fuel cell in which a change rate of output of the fuel cell is more than a predetermined amount.

5. The fuel supply apparatus according to claim 4, wherein
during the double-injection-valve injection control, the injection control unit performs a feedback control to control an injection amount of the gas fuel to be injected by the second fuel injection valve according to a difference between a requested injection amount of the gas fuel and an injection amount of the gas fuel injected by the first fuel injection valve.

6. The fuel supply apparatus according to claim 4, wherein
during the high output of the fuel cell, the injection control unit is configured to perform:
the double-injection-valve injection control when a pressure difference between a target pressure and an actual pressure of an inner pressure of the fuel cell is larger than a pressure difference allowing pressure increase of the actual pressure by actuation of the first fuel injection valve, and
the first-injection-valve injection control to actuate the first fuel injection valve but stop the second fuel injection valve when the pressure difference between the target pressure and the actual pressure of the fuel cell is equal to or less than the pressure difference allowing pressure increase of the actual pressure by actuation of the first fuel injection valve.

7. The fuel supply apparatus according to claim 1, further including an ejector provided in a position downstream of the fuel injection unit and upstream of the fuel cell,
wherein the ejector is configured to introduce the gas fuel injected from the fuel injection unit, generating a negative pressure, suck fuel offgas exhausted from the fuel cell by use of the negative pressure, merge the sucked fuel offgas with the introduced gas fuel, and circulate to the fuel cell, and
an introduction port of the ejector for the gas fuel is connected to an injection port of the first fuel injection valve for the gas fuel.

8. The fuel supply apparatus according to claim 7, wherein the injection control unit is configured to cause the fuel injection unit to intermittently inject the gas fuel when a freezing generation condition that freezing occurs inside the ejector is satisfied during execution of the first-injection-valve injection control in which the first fuel injection valve is actuated but the second fuel injection valve is stopped.

9. The fuel supply apparatus according to claim 1, wherein the first fuel injection valve is a fuel injection valve configured to open and close the injection port for the gas fuel by actuation of by a linear actuator.

10. The fuel supply apparatus according to claim 4, wherein the injection control unit is configured to perform a first-injection-valve injection control to actuate the first fuel injection valve but stop the second fuel injection valve during low output of the fuel cell in which a change rate of output of the fuel cell is less than a predetermined amount.

11. The fuel supply apparatus according to claim 4, wherein,
during the first-injection-valve injection control, the injection control unit performs the control so that an actual pressure of an inner pressure of the fuel cell becomes a lower limit of a target pressure.

12. The fuel supply apparatus according to claim 6, wherein
during the double-injection-valve injection control, the injection control unit performs a feedback control to control an injection amount of the gas fuel to be injected by the second fuel injection valve according to a difference between a requested injection amount of the gas fuel and an injection amount of the gas fuel injected by the first fuel injection valve.

13. The fuel supply apparatus according to claim 7, wherein the injection control unit is configured to perform a first-injection-valve injection control to actuate the first fuel injection valve but stop the second fuel injection valve during low output of the fuel cell in which a change rate of output of the fuel cell is less than a predetermined amount.

14. The fuel supply apparatus according to claim 7, wherein,
during the first-injection-valve injection control, the injection control unit performs the control so that an actual pressure of an inner pressure of the fuel cell becomes a lower limit of a target pressure.

15. The fuel supply apparatus according to claim 7, wherein the injection control unit is configured to perform a double-injection-valve injection control to actuate both the first fuel injection valve and the second fuel injection valve during high output of the fuel cell in which a change rate of output of the fuel cell is more than a predetermined amount.

16. The fuel supply apparatus according to claim 7, wherein
during the double-injection-valve injection control, the injection control unit performs a feedback control to control an injection amount of the gas fuel to be injected by the second fuel injection valve according to a difference between a requested injection amount of the gas fuel and an injection amount of the gas fuel injected by the first fuel injection valve.

17. The fuel supply apparatus according to claim 7, wherein
during the high output of the fuel cell, the injection control unit is configured to perform:
the double-injection-valve injection control when a pressure difference between a target pressure and an actual pressure of an inner pressure of the fuel cell is larger than a pressure difference allowing pressure increase of the actual pressure by actuation of the first fuel injection valve, and
the first-injection-valve injection control to actuate the first fuel injection valve but stop the second fuel injection valve when the pressure difference between the target pressure and the actual pressure of the fuel cell is equal to or less than the pressure difference allowing pressure increase of the actual pressure by actuation of the first fuel injection valve.

18. The fuel supply apparatus according to claim 9, wherein the injection control unit is configured to perform a first-injection-valve injection control to actuate the first fuel injection valve but stop the second fuel injection valve during low output of the fuel cell in which a change rate of output of the fuel cell is less than a predetermined amount.

19. The fuel supply apparatus according to claim 9, wherein,
during the first-injection-valve injection control, the injection control unit performs the control so that an actual pressure of an inner pressure of the fuel cell becomes a lower limit of a target pressure.

20. The fuel supply apparatus according to claim 9, wherein the injection control unit is configured to perform a double-injection-valve injection control to actuate both the first fuel injection valve and the second fuel injection valve during high output of the fuel cell in which a change rate of output of the fuel cell is more than a predetermined amount.
